(19) United States
(12) Patent Application Publication
(10) Pub. No.: US 2024/0083296 A1
(43) Pub. Date: Mar. 14, 2024

(54) CONTROL DEVICE AND DISPLAY DEVICE

(71) Applicant: TOYOTA JIDOSHA KABUSHIKI KAISHA, Toyota-shi (JP)

(72) Inventors: Sui KURIHASHI, Sunto-gun (JP); Tomohiko INOUE, Tokyo (JP)

(73) Assignee: TOYOTA JIDOSHA KABUSHIKI KAISHA, Toyota-shi (JP)

(21) Appl. No.: 18/232,509

(22) Filed: Aug. 10, 2023

(30) Foreign Application Priority Data
Sep. 14, 2022 (JP) 2022-146505

(51) Int. Cl. B60L 58/12; B60L 15/20

(52) U.S. Cl. CPC B60L 58/12; B60L 15/2045

(57) ABSTRACT

Disclosed is a control device that executes display control for causing a display device to display information on a vehicle capable of traveling using electric power of a battery. Further, the control device, while the vehicle travels toward a predetermined destination, causes the display device to display a transition of a travelable distance corresponding to an SOC of the battery and a transition of a distance to the destination, and causes the display device to display a predicted remaining SOC of the battery when the vehicle arrives at the destination.

### CROSS-REFERENCE TO RELATED APPLICATION(S)

The present application claims priority to and incorporates by reference the entire contents of Japanese Patent Application No. 2022-146505 filed in Japan on Sep. 14, 2022.

### BACKGROUND

The present disclosure relates to a control device and a display device.

Japanese Laid-open Patent Publication No. 2014-54100 discloses that a travelable distance of an electric vehicle equipped with a motor and a battery is calculated based on an SOC of the battery, and the travelable distance is displayed on a display device.

### SUMMARY

There is a need for providing a control device and a display device capable of avoiding exhaustion of energy required for traveling.

According to an embodiment, a control device, that executes display control for causing a display device to display information on a vehicle capable of traveling using electric power of a battery, is directed to, while the vehicle travels toward a predetermined destination, cause the display device to display a transition of a travelable distance corresponding to an SOC of the battery and a transition of a distance to the destination, and cause the display device to display a predicted remaining SOC of the battery when the vehicle arrives at the destination.

According to an embodiment, a display device, that displays information on a vehicle capable of traveling using electric power of a battery, is directed to, while the vehicle travels toward a predetermined destination, display a transition of a travelable distance corresponding to an SOC of the battery and a transition of a distance to the destination, and display a predicted remaining SOC of the battery when the vehicle arrives at the destination.

### BRIEF DESCRIPTION OF THE DRAWINGS

FIG. 1 is a block diagram schematically illustrating a vehicle according to a first embodiment;

FIG. 2 is a flowchart illustrating a display control flow;

FIG. 3 is a diagram illustrating a display example of a transition of a travelable distance, a transition of a distance to a destination, and an estimated SOC;

FIG. 4 is a diagram illustrating another display example of the transition of the travelable distance, the transition of the distance to the destination, and the estimated SOC;

FIG. 5 is a block diagram schematically illustrating a vehicle according to a second embodiment;

FIG. 6 is a diagram illustrating a display example of a transition of a travelable distance in a third embodiment; and

FIG. 7 is a flowchart illustrating a display control flow according to a fourth embodiment.

### DETAILED DESCRIPTION

In a vehicle that travels using electric power of a battery as described in Japanese Laid-open Patent Publication No. 2014-54100, it is desirable to avoid traveling impossibility due to an electricity shortage.

Hereinafter, a control device and a display device according to embodiments of the present disclosure will be specifically described with reference to the drawings. Note that the present disclosure is not limited to the embodiments described below.

### First Embodiment

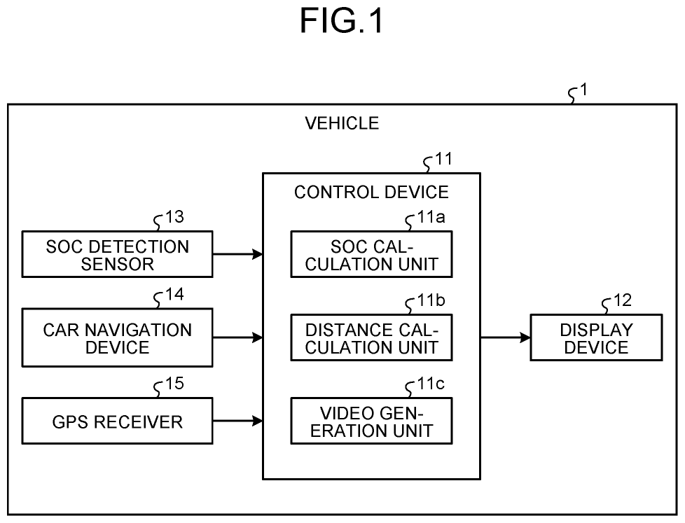

FIG. 1 is a block diagram schematically illustrating a vehicle according to a first embodiment. A vehicle 1 is an electric vehicle equipped with a motor as a power source, and the vehicle 1 travels when the motor is driven by supplying electric power stored in a battery to the motor. Since the vehicle 1 travels by power obtained by consuming electric power, the state of charge (SOC) of the battery decreases due to traveling. However, when the vehicle 1 is in a traveling state with good energy efficiency, electricity cost is improved, thereby making it possible to increase a traveling distance. Therefore, when the vehicle 1 travels toward a destination, a change in energy margin to the destination is provided to a driver as visual information.

The vehicle 1 includes a control device 11, a display device 12, an SOC detection sensor 13, a car navigation device 14, and a GPS receiver 15.

The control device 11 includes an electronic control device that controls the vehicle 1. The electronic control device includes a microcontroller including a CPU, a RAM, a ROM, and an input/output interface. The control device 11 performs signal processing according to a program stored in advance in the ROM. Signals from various sensors mounted on the vehicle 1, such as the SOC detection sensor 13, are input to the control device 11.

The SOC detection sensor 13 detects the SOC of a battery that stores electric power for traveling. The SOC detection sensor 13 outputs a signal including a detected value to the control device 11. The control device 11 performs calculation based on the signal input from the SOC detection sensor 13 during traveling, and calculates the current SOC.

In addition, the control device 11 executes display control for causing the display device 12 to display information on the vehicle 1 based on the signal input from the SOC detection sensor 13 during traveling. The control device 11 includes a control unit configured to execute the display control. When executing the display control, the control device 11 generates an image showing a transition of a travelable distance and causes the display device 12 to display the image.

More specifically, the control device 11 includes an SOC calculation unit 11a, a distance calculation unit 11b, and a video generation unit 11c.

The SOC calculation unit 11a calculates the current SOC in the battery based on the signal input from the SOC detection sensor 13. The SOC calculation unit 11a outputs a calculated value to the distance calculation unit 11b.

The distance calculation unit 11b calculates a travelable distance according to the current SOC. The distance calculation unit 11b calculates the travelable distance using the value input from the SOC calculation unit 11a. At that time, the distance calculation unit 11b calculates the travelable distance in a case where the control device 11 executes normal traveling control (base control).

Further, the control device 11 acquires navigation information from the car navigation device 14 and acquires position information on the vehicle 1 from the GPS receiver 15. When the driver of the vehicle 1 operates the car navigation device 14 to set a destination, information on the destination set by the car navigation device 14 is input to the control device 11 as navigation information. In addition, a positioning signal received by the GPS receiver 15 is input to the control device 11.

Therefore, the SOC calculation unit 11a can calculate (estimate) a remaining SOC when the vehicle 1 arrives at the destination based on the information on the destination and the current SOC. Similarly, the distance calculation unit 11b can calculate a distance to the destination based on the information on the destination and the current position information. Then, while the vehicle 1 is traveling toward the destination, the SOC calculation unit 11a calculates the estimated SOC at the time of arrival, and the distance calculation unit 11b calculates the distance to the destination.

The video generation unit 11c generates an image representing the transition of the distance to the destination, the transition of the travelable distance, and the SOC at the time of arrival at the destination. The video generation unit 11c generates an image of a polygonal line graph and an image of the estimated SOC. The polygonal line graph displays a polygonal line indicating the transition of the travelable distance and a polygonal line indicating the transition of the distance to the destination. By simultaneously displaying the polygonal line indicating the transition of the travelable distance and the polygonal line indicating the transition of the distance to the destination, the magnitude of an energy margin can be represented by a degree of divergence between the two polygonal lines. In addition, since the polygonal line graph is time-series data, the polygonal line graph represents a change in the energy margin. Then, the video generation unit 11c outputs the generated image data to the display device 12.

The display device 12 displays the information on the vehicle 1. The display device 12 is a display disposed in the interior of the vehicle 1 and configured to display an image at a position visually recognizable by the driver of the vehicle 1. For example, the display device 12 includes a multi-information display, a head-up display, or the like. Further, the display device 12 is controlled by the control device 11, and displays an image according to a signal input from the control device 11.

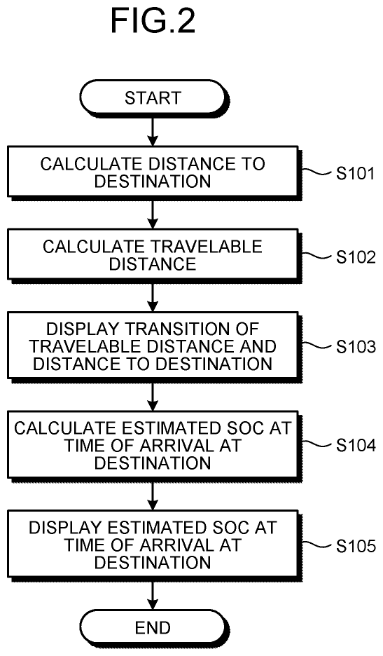

FIG. 2 is a flowchart illustrating a display control flow. Note that the control illustrated in FIG. 2 is repeatedly executed by the control device 11 while the vehicle 1 is traveling.

The control device 11 calculates a distance to a destination (step S101). In step S101, a distance from a current position of the vehicle 1 to a destination is calculated for a destination determined by the car navigation device 14.

The control device 11 calculates a travelable distance of the vehicle 1 (step S102). In step S102, a travelable distance according to a current SOC of a battery is calculated.

Then, the control device 11 displays the transition of the travelable distance and the transition of the distance to the destination on the display device 12 (step S103). In step S103, the transition of the distance to the destination calculated in step S101 and the transition of the travelable distance calculated in step S102 are displayed on the display device 12.

The control device 11 calculates a remaining SOC estimated at the time of arrival at the destination (step S104). In step S104, the SOC at the time of arrival at the destination is estimated based on the current SOC and the distance to the destination.

Then, the control device 11 displays the estimated SOC at the time of arrival at the destination on the display device 12 (step S105). In step S105, information on the estimated SOC is displayed on the display device 12. When the processing of step S105 is executed, this control routine ends.

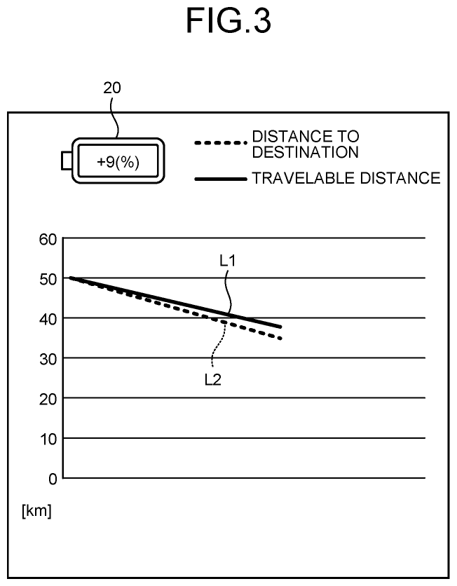

FIG. 3 is a diagram illustrating a display example of the transition of the travelable distance, the transition of the distance to the destination, and the estimated SOC. The display device 12 displays a polygonal line graph showing the transition of the travelable distance and the transition of the distance to the destination. The transition of the travelable distance is represented by a polygonal line L1 indicated by a solid line. The distance to the destination is represented by a polygonal line L2 indicated by a broken line. In the polygonal line graph illustrated in FIG. 3, the right end portion of each of the polygonal lines L1 and L2 represents the latest state, and the left side portion of each of the polygonal lines L1 and L2 represents past information.

As illustrated in FIG. 3, in the case of a transition in which the polygonal line L1 representing the travelable distance is located at a position higher than the polygonal line L2 representing the distance to the destination, a difference between the polygonal line L1 and the polygonal line L2 represents an energy margin in a state where the travelable distance is longer than the distance to the destination. The state illustrated in FIG. 3 indicates that the vehicle 1 continues to travel in a state where the travelable distance is longer than the distance to the destination, and a difference between the travelable distance and the distance to the destination gradually increases, that is, the energy margin gradually increases during traveling.

The estimated SOC at the time of arrival at the destination is represented by an image 20. The image 20 is an image representing the remaining SOC (estimated SOC) estimated at the time of arrival at the destination. In the example illustrated in FIG. 3, “+9(%)” is displayed. This indicates that the SOC estimated at the time of arrival at the destination is “+9%” with respect to “0%”, which is in the fully discharged state. That is, the image 20 illustrated in FIG. 3 indicates that the remaining SOC at the time of arrival is in the positive range, and indicates that the vehicle can arrive at the destination without charging on the way even if the vehicle continues to travel at the current SOC. If the travelable distance is shorter than the distance to the destination, the estimated SOC can be expressed as “0%” indicating that energy is exhausted or “−5%” indicating a negative range. In such a case, it means that charging is required in the middle of traveling.

As described above, according to the first embodiment, since the transition of the travelable distance and the transition of the distance to the destination can be visualized by the polygonal line graph, a change in the energy margin can be displayed. As a result, it is possible to provide a driver with information serving as a material configured to determine whether a vehicle can arrive at a destination with current remaining energy. As a result, it is possible to provide a driver with information serving as a material configured to determine charging, and as such, it is possible to avoid exhaustion of energy required for traveling.

Note that the vehicle 1 only needs to be an electric vehicle equipped with a motor serving as a power source for traveling, and whether the vehicle 1 is a battery electric vehicle (BEV) equipped with only a motor or a hybrid electric vehicle (HEV) equipped with a motor and an engine is not particularly limited.

Furthermore, the display device 12 may be the car navigation device 14. In short, the display device 12 only needs to be configured by a human machine interface (HMI), may be a device mounted on the vehicle 1, or may be a portable terminal brought into the vehicle 1 by a driver, such as a smartphone. In a case where the display device 12 is a smartphone, the control device 11 is configured to be able to communicate with the smartphone, and image data transmitted from the control device 11 is displayed on a display of the smartphone.

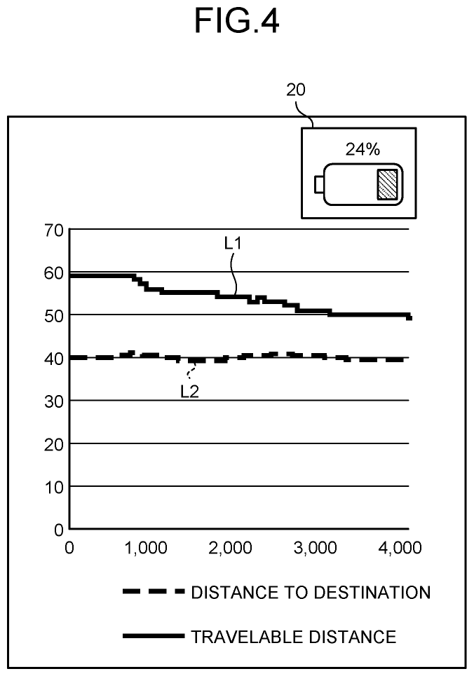

Furthermore, the image displayed on the display device 12 is not limited to the image illustrated in FIG. 3. For example, as illustrated in FIG. 4, the polygonal line L1 representing the transition of the travelable distance, the polygonal line L2 representing the transition of the distance to the destination, and the image 20 representing the estimated SOC at the time of arrival can be displayed. In the example illustrated in FIG. 4, “24%” is displayed. This indicates that the state of charge is “24%” as a numerical value between “100%”, which is the fully charged state, and “00”, which is the fully discharged state. The state illustrated in FIG. 4 indicates that the vehicle arrives at the destination with only 24% of the SOC remaining, and indicates that the vehicle can arrive at the destination without charging on the way when the vehicle continues to travel at the current SOC.

Although the example illustrated in FIG. 4 shows a transition in which the polygonal line L1 representing the travelable distance is located at a position higher than the polygonal line L2 representing the distance to the destination, the travelable distance is shortened in a state where the distance to the destination is not shortened. Therefore, it indicates that a difference between the travelable distance and the distance to the destination gradually narrows, that is, the energy margin gradually decreases.

### Second Embodiment

In a second embodiment, a travelable distance in a case where normal traveling control is executed and a travelable distance in a case where control for reduction of energy consumption during traveling is executed are displayed as a travelable distance. In the description of the second embodiment, the description of the same configuration as that of the first embodiment will be omitted, and reference numeral of the first embodiment will be used for the same configuration.

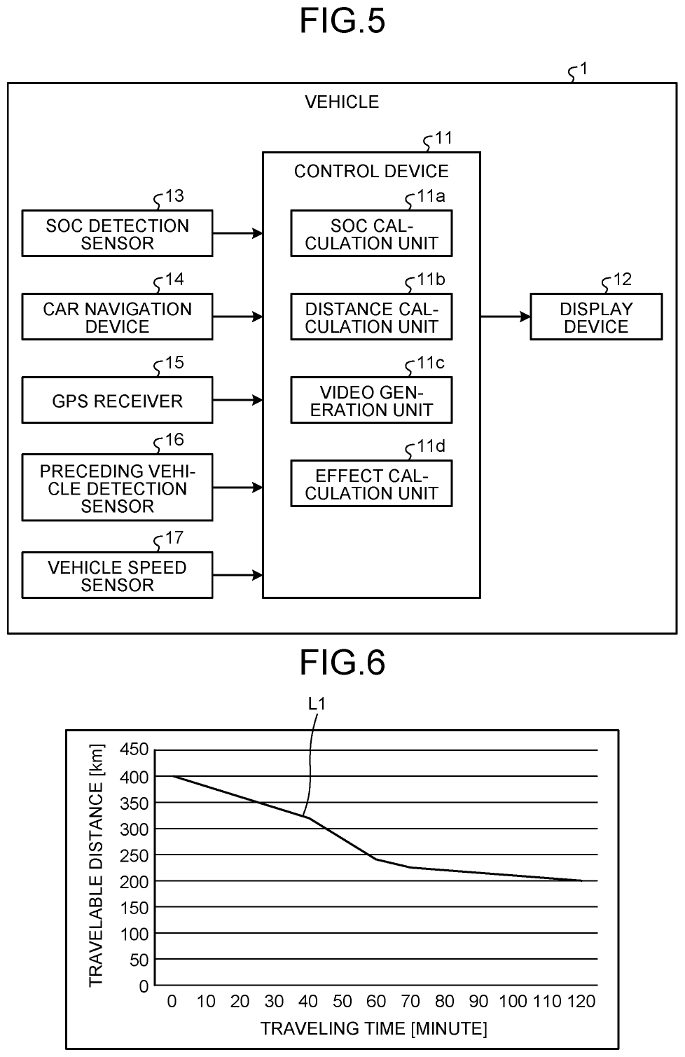

FIG. 5 is a block diagram schematically illustrating a vehicle according to the second embodiment. A vehicle 1 includes a control device 11, a display device 12, an SOC detection sensor 13, a car navigation device 14, a GPS receiver 15, a preceding vehicle detection sensor 16, and a vehicle speed sensor 17.

The control device 11 executes normal traveling control (base control) and traveling control for reduction of energy consumption during traveling (hereinafter, referred to as reduction control). The reduction control is a travel mode such as an eco-travel mode or a platooning mode. By executing the reduction control, the control device 11 controls the vehicle 1 in a state in which electric power consumption during traveling is reduced as compared with a case in which the normal traveling control is executed. The state in which the normal traveling control is executed is a base control state. That is, the base control state can be expressed as a control state in which the reduction control is not executed. The driver can select execution of the reduction control by operating a button near a steering wheel. The control device 11 can determine whether the driver has selected the reduction control by detecting an operation of a button for selecting the eco-travel mode, a button for selecting the platooning mode, or the like.

For example, when the control device 11 executes the platooning mode as the reduction control, the vehicle 1 executes platooning. The vehicle 1 is equipped with a system (automatic following system) that follows a preceding vehicle traveling in front of the own vehicle, such as radar cruise control, automatic cruise control, and adaptive cruise control. Therefore, the control device 11 can execute the platooning mode during automatic driving. The effect of reducing energy consumption is an effect (platooning effect) obtained by the vehicle 1 by the platooning.

The control device 11 includes an SOC calculation unit 11a, a distance calculation unit lib, a video generation unit 11c, and an effect calculation unit 11d.

The effect calculation unit 11d calculates an effect of reducing energy consumption by the reduction control. The effect calculation unit 11d calculates an electricity cost improvement effect obtained by the vehicle 1 when the reduction control is executed.

When the control device 11 executes the platooning mode, the effect calculation unit 11d calculates an effect of reducing energy consumption (platooning effect) obtained by the vehicle 1 by following the preceding vehicle (platooning). The effect calculation unit 11d calculates the platooning effect based on a size of the preceding vehicle, an inter-vehicle distance between the preceding vehicle and the vehicle 1, and a vehicle speed of the vehicle 1. That is, the effect calculation unit 11d estimates the current platooning effect using the information acquired from the preceding vehicle detection sensor 16 and the vehicle speed sensor 17.

Specifically, the effect calculation unit 11d calculates the effect of reducing air resistance due to the platooning. The air resistance received by the vehicle 1 during traveling is obtained by multiplying a frontal projected area of the vehicle 1, an air resistance coefficient, and a pressure. The effect of reducing the air resistance obtained by the platooning can be calculated based on the size of the preceding vehicle, the distance (inter-vehicle distance) between the vehicle 1 and the preceding vehicle, and the vehicle speed. In this case, the size of the preceding vehicle and the inter-vehicle distance from the preceding vehicle can be calculated based on preceding vehicle information acquired by the preceding vehicle detection sensor 16.

For example, the effect calculation unit 11d analyzes an image of the front of the own vehicle acquired by a front camera included in the preceding vehicle detection sensor 16, calculates the size of the preceding vehicle, and calculates the inter-vehicle distance between the vehicle 1 and the preceding vehicle. Alternatively, the effect calculation unit 11d calculates the inter-vehicle distance between the preceding vehicle and the vehicle 1 based on a measurement result of a radar acquired by a millimeter wave radar included in the preceding vehicle detection sensor 16. The vehicle speed can be detected by the vehicle speed sensor 17. Then, the effect calculation unit 11d calculates the effect of reducing the air resistance based on the size of the preceding vehicle, the inter-vehicle distance, and the vehicle speed. As an example, when the inter-vehicle distance from the preceding vehicle is short, the effect of reducing the air resistance becomes large, and when the inter-vehicle distance from the preceding vehicle is long, the effect of reducing the air resistance becomes small.

In addition, the distance calculation unit 11b calculates a first travelable distance in a case where the normal traveling control is executed and a second travelable distance in a case where a vehicle travels by executing the reduction control. When calculating the second travelable distance, the distance calculation unit 11b calculates the travelable distance based on the effect of reducing energy consumption calculated by the effect calculation unit 11d.

The video generation unit 11c generates an image indicating the first travelable distance and the second travelable distance calculated by the distance calculation unit lib. The image indicating the first travelable distance and the image indicating the second travelable distance generated by the video generation unit 11c are output from the control device 11 to the display device 12. The control device 11 executes display control for causing the display device 12 to display the first travelable distance and the second travelable distance in real time.

The display device 12 displays, as a polygonal line L1 representing the transition of the travelable distance, a first polygonal line representing the transition of the first travelable distance when the normal traveling control is executed and a second polygonal line representing the transition of the second travelable distance when the reduction control is executed. In the second embodiment, two polygonal lines representing the transition of the travelable distance are displayed. As a result, the display device 12 can display a difference in energy margin between the case of performing the normal traveling control and the case of performing the reduction control. Further, the display device 12 can display a polygonal line L2 representing the transition of the distance to the destination and an image 20 representing the estimated SOC at the time of arrival in addition to the two polygonal lines representing the transition of the travelable distance.

As described above, according to the second embodiment, it is possible to display, on the display device 12, the transition of the first travelable distance in a case where the normal traveling control is executed and the transition of the second travelable distance in a case where the reduction control is executed. Therefore, the driver of the vehicle 1 can visually recognize a difference in the transition of the travelable distance according to the traveling control, and as such, it is possible to motivate the driver to execute a traveling state having a high reduction effect.

When the vehicle 1 is a vehicle equipped with an engine, the control device 11 calculates an effect of reducing fuel consumed during traveling (fuel consumption improvement effect). That is, the effect calculation unit 11d calculates an effect that can improve fuel consumption.

In addition, the second travelable distance is not limited to a case in which the control device 11 executes the reduction control during traveling, and may be a case in which a vehicle is controlled to enter a traveling state in which energy consumption can be reduced by an operation of the driver. That is, even in a state where the eco-travel mode or the platooning mode is not executed, it is possible to realize a traveling state in which energy consumption during traveling is reduced by a driving operation of a driver. Therefore, the effect calculation unit 11d may calculate the reduction effect on the assumption of a traveling state in which the reduction of energy consumption can be expected by an operation of a driver (manual driving).

### Third Embodiment

In a third embodiment, unlike the first embodiment, a distance to a destination and an estimated SOC are not displayed, and only information indicating a transition of a travelable distance is displayed as a polygonal line graph on a display device 12. In the description of the third embodiment, the description of the same configuration as that of the first embodiment will be omitted, and reference numeral of the first embodiment will be used for the same configuration.

As illustrated in FIG. 6, a control device 11 of the third embodiment causes the display device 12 to display a polygonal line graph including a polygonal line L1 representing a transition of a travelable distance. This travelable distance is calculated by a distance calculation unit lib. The control device 11 displays the travelable distance in time series.

According to the third embodiment, a driver who looks at the information displayed on the display device 12 can check an elapsed time and a change in the travelable distance at that time, and can estimate what contributes to improvement of electricity costs in association with the operation status of the driver's own driving or driving assist function.

### Fourth Embodiment

Unlike the second embodiment, a fourth embodiment is configured to be able to suggest a driver to execute traveling control for reduction of energy consumption even when three pieces of information on a travelable distance, a distance to a destination, and an estimated SOC at the time of arrival at the destination are not displayed on a display device 12. In the description of the fourth embodiment, the description of the same configuration as that of the second embodiment will be omitted, and reference numeral of the second embodiment will be used for the same configuration.

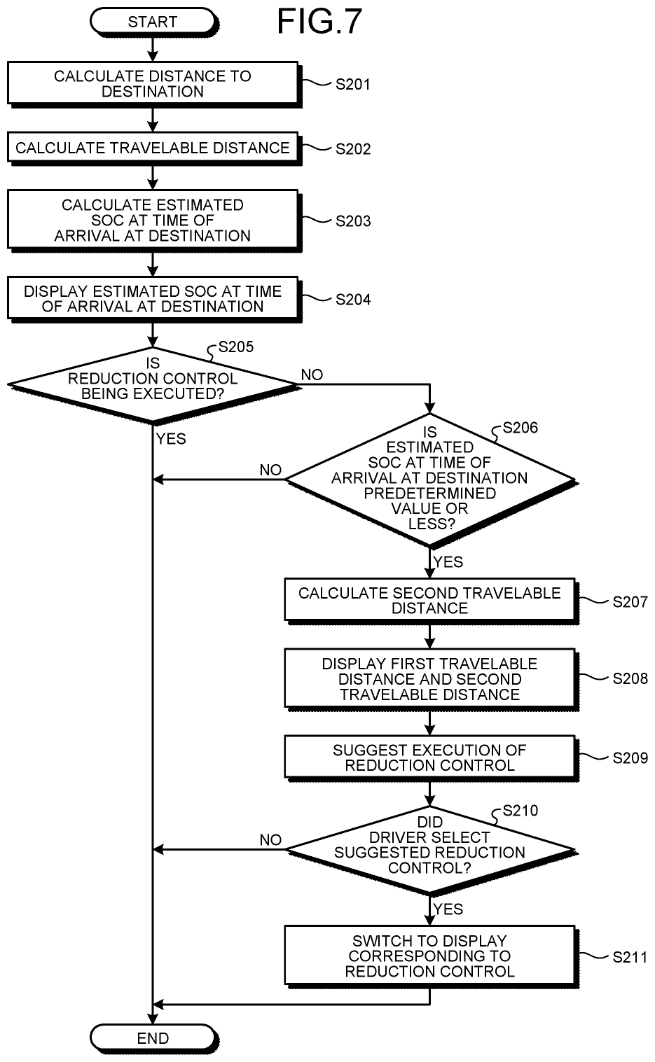

FIG. 7 is a flowchart illustrating a display control flow according to the fourth embodiment. Note that control illustrated in FIG. 7 is repeatedly executed by a control device 11 while a vehicle 1 is traveling.

The control device 11 calculates a distance to a destination (step S201). In step S201, a distance from a current position of the vehicle 1 to a destination is calculated for a destination determined by a car navigation device 14.

The control device 11 calculates a travelable distance of the vehicle 1 (step S202). In step S202, a travelable distance corresponding to a current SOC of a battery, which is a first travelable distance, is calculated.

The control device 11 calculates a remaining SOC estimated at the time of arrival at the destination (step S203). In step S203, the SOC at the time of arrival at the destination is estimated based on the current SOC and the distance to the destination. In step S203, the control device 11 calculates an estimated SOC at the time of arrival at the destination.

Then, the control device 11 displays the estimated SOC at the time of arrival at the destination on the display device 12 (step S204). In step S204, information on the estimated SOC is displayed on the display device 12.

The control device 11 determines whether reduction control is being executed (step S205).

When it is determined that the reduction control is being executed (step S205: Yes), this control routine ends.

When it is determined that the reduction control is not being executed (step S205: No), the control device 11 determines whether the estimated SOC at the time of arrival at the destination is a predetermined value or less (step S206). The predetermined value is a preset value.

When it is determined that the estimated SOC at the time of arrival at the destination is greater than the predetermined value (step S206: No), this control routine ends.

When it is determined that the estimated SOC at the time of arrival at the destination is equal to or less than the predetermined value (step S206: Yes), the control device 11 calculates a second travelable distance (step S207). In step S207, a travelable distance in a case where the vehicle travels by executing the reduction control, which is the second travelable distance, is calculated.

The control device 11 causes the display device 12 to display the first travelable distance and the second travelable distance (step S208). In step S208, the first travelable distance calculated by the processing in step S202 and the second travelable distance calculated by the processing in step S207 are displayed on the display device 12. For example, the display device 12 can display a difference between the first travelable distance and the second travelable distance in a visually recognizable image.

In addition, the control device 11 causes the display device 12 to display a display configured to suggest execution of the reduction control (step S209). In step S209, a message or the like recommending the reduction control is displayed on the display device 12. Further, in step S209, it is only necessary to display the suggestion on the display device 12, and it is also possible to display the suggestion on the display device 12 and output a notification sound or a voice from a speaker. Since the first travelable distance and the second travelable distance are displayed on the display device 12, the driver can determine whether it is necessary to execute the reduction control after checking the expected reduction effect.

Then, the control device 11 determines whether the driver selects the suggested reduction control (step S210). In step S210, it is determined whether a selection input such as a button operation is detected, whereby it is determined whether the driver desires to execute the reduction control.

When it is determined that the driver does not select the suggested reduction control (step S210: No), this control routine ends.

When it is determined that the driver selects the suggested reduction control (step S210: Yes), the control device 11 switches to a display corresponding to the reduction control (step S211). In step S211, the information displayed on the display device 12 is switched to the display corresponding to the reduction control. For example, the display state is switched so that the first travelable distance is not displayed and a state in which the second travelable distance is displayed is maintained. When the processing of step S211 is executed, this control routine ends.

According to the fourth embodiment, even if three of the travelable distance, the distance to the destination, and the estimated SOC at the time of arrival at the destination are not displayed together, it is possible to suggest execution of traveling control (reduction control) for reducing energy consumption during traveling when it is determined that the estimated SOC at the time of arrival at the destination is lower than a predetermined value. As a result, it is possible to provide a driver with information serving as a material configured to determine charging, and as such, it is possible to avoid exhaustion of energy required for traveling.

In the present disclosure, by displaying the transition of a travelable distance and the transition of a distance to a destination, a change in energy margin is displayed, and information indicating whether a vehicle can arrive at the destination with the current SOC can be provided to a driver. As a result, it is possible to provide a driver with information serving as a material configured to determine charging, and as such, it is possible to avoid exhaustion of energy required for traveling.

According to an embodiment, by displaying the transition of the travelable distance and the transition of the distance to the destination, a change in energy margin is displayed, and information indicating whether a vehicle can arrive at the destination with the current SOC can be provided to a driver. As a result, it is possible to provide a driver with information serving as a material configured to determine charging, and as such, it is possible to avoid exhaustion of energy required for traveling.

According to an embodiment, it is possible to provide a driver with information indicating whether a vehicle can arrive at a destination with a current remaining energy when traveling under the normal traveling control.

According to an embodiment, it is possible not only to display a difference in travelable distance between a case of traveling with the normal traveling control and a case of traveling with the control for reduction of energy consumption during traveling, but also to provide a driver with information indicating whether a vehicle can arrive at a destination with a current remaining energy when traveling with these controls.

According to an embodiment, a driver can determine whether it is necessary to execute traveling control for reduction of energy consumption.

According to an embodiment, by displaying the transition of the travelable distance and the transition of the distance to the destination, it is possible to display a change in energy margin, and to provide a driver with information indicating whether a vehicle can arrive at the destination with the current SOC. As a result, it is possible to provide a driver with information serving as a material configured to determine charging, and as such, it is possible to avoid exhaustion of energy required for traveling.

According to an embodiment, it is possible to provide a driver with information indicating whether a vehicle can arrive at a destination with a current remaining energy when traveling under the normal traveling control.

According to an embodiment, it is possible not only to display a difference in travelable distance between a case of traveling with the normal traveling control and a case of traveling with the control for reduction of energy consumption during traveling, but also to provide a driver with information indicating whether a vehicle can arrive at a destination with a current remaining energy when traveling with these controls.

According to an embodiment, a driver can determine whether it is necessary to execute traveling control for reduction of energy consumption.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control device configured to execute display control for causing a display device to display information on a vehicle capable of traveling using electric power of a battery, wherein the control device is configured to, while the vehicle travels toward a predetermined destination, cause the display device to display a transition of a travelable distance corresponding to an SOC of the battery and a transition of a distance to the destination, and cause the display device to display a predicted remaining SOC of the battery when the vehicle arrives at the destination.

2. The control device according to claim 1, wherein the travelable distance is a travelable distance in a case where the vehicle executes normal traveling control.

3. The control device according to claim 1,
wherein the travelable distance includes:
a first travelable distance in a case where the vehicle executes normal traveling control; and
a second travelable distance in a case where the vehicle executes traveling control for reduction of energy consumption during traveling, and
wherein the control device causes the display device to display a transition of the first travelable distance and a transition of the second travelable distance.

4. The control device according to claim 1, wherein, upon determining that the predicted remaining SOC of the battery when the vehicle arrives at the destination is lower than a preset predetermined value while the vehicle travels toward the predetermined destination, the control device causes the display device to display a display configured to suggest execution of traveling control for reduction of energy consumption during traveling.

5. A display device configured to display information on a vehicle capable of traveling using electric power of a battery, wherein the display device is configured to, while the vehicle travels toward a predetermined destination, display a transition of a travelable distance corresponding to an SOC of the battery and a transition of a distance to the destination, and display a predicted remaining SOC of the battery when the vehicle arrives at the destination.

6. The display device according to claim 5, wherein the travelable distance is a travelable distance in a case where the vehicle executes normal traveling control.

7. The display device according to claim 5,
wherein the travelable distance includes:
a first travelable distance in a case where the vehicle executes normal traveling control; and
a second travelable distance in a case where the vehicle executes traveling control for reduction of energy consumption during traveling, and
wherein the display device displays a transition of the first travelable distance and a transition of the second travelable distance.

8. The display device according to claim 5, wherein, upon determining that the predicted remaining SOC of the battery when the vehicle arrives at the destination is lower than a preset predetermined value while the vehicle travels toward the predetermined destination, the display device displays a display configured to suggest execution of traveling control for reduction of energy consumption during traveling.
